(19) United States
(12) Patent Application Publication
(10) Pub. No.: US 2011/0018683 A1
(43) Pub. Date: Jan. 27, 2011

(54) MANAGEMENT OF THE IDENTITIES OF USERS IN A SYSTEM

(75) Inventors: Frédéric Rousseau, Montigny Le Bretonneux (FR); Stéphane Eloy, Courbevoie (FR)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Eads Secure Networks, Elancourt (FR)

(21) Appl. No.: 12/933,407

(22) PCT Filed: Mar. 18, 2009
(86) PCT No.: PCT/EP09/53200

§ 371 Date: Sep. 17, 2010

(30) Foreign Application Priority Data
Mar. 18, 2008 (FR) 0851754

(51) Int. Cl. G06F 7/04

(52) U.S. Cl. 340/5.61

(57) ABSTRACT

The identity of a user to be associated with a terminal adapted for communication in a communication network is managed. The network provides a service based on the identity of the user. A contactless transaction is established at the terminal with an identification entity. During the transaction, a piece of information on the identity of the user stored in the identification entity is received. Finally, the identity of the user obtained from said information is stored. The identity of the user is erased at the terminal when the terminal is subjected to a specific action.

### PRIORITY CLAIM

This application is a 371 filing of PCT/EP2009/053200 filed Mar. 18, 2009, which claims priority from French Application for Patent 0851754 filed Mar. 18, 2008, the disclosures of which are hereby incorporated by reference.

### TECHNICAL FIELD

This invention relates to the management of a user identity for an electronic terminal, and more particularly to the temporary association of a user identity with a terminal of a system.

### BACKGROUND

Some systems provide services to users based on the respective identities of these users. Thus, when, via a terminal of the system, a user wishes to access a service to which they purchased a subscription, for example, they associate an identification entity with this terminal of the system, whereby their user identity is accessible. Such an identification entity, for example, can be a identity reader or an identity storage medium such as an identification card, or a payment card or a subscription card for a profiled service, e.g., a UICC/USIM card (for “Universal Integrated Circuit Card/Universal Subscriber Identity Module”) in the context of the GSM or 3GPP networks. In the example relating to the GSM network using an identification entity compliant with the ISO/IEC 7816 standard, the latter and the terminal are in physical contact since, and, although removable, this identification entity is generally kept inside the terminal housing. Consequently, when the terminal is stolen, the thief can usurp the identity of the subscriber since, by stealing the terminal, they have simultaneously retrieved the identification entity used by this subscriber.

Alternatively, provisions can be made for the interface between the terminal and the identification entity to be an electromagnetic interface, such as a contactless radio interface. With such an interface, the terminal and the identification entity are not physically connected. The security level thereof is then improved because, when a terminal is stolen, the identification entity is not necessarily stolen.

However, irrespective of the type of interface used, it bears noting that the terminal and the identification entity must be connected during the entire period of use of the communication service in question.

This may be the case, for example, for a financial transaction. In this case, if, during the course of the financial transaction, it is detected that the interface between the identification entity and terminal is broken, the entire transaction must be repeated from the beginning.

Thus, when the interface is an electromagnetic interface, it is necessary for the distance separating the identification entity and the terminal to be sufficiently small so as to exceed a minimum quality threshold for the electromagnetic interface, below which the transaction between the identification entity and the terminal would be interrupted. This threshold distance is dependent upon the standard used for this interface. As a matter of fact, for example, the proximity interface standards ISO/IEC 14443, ISO/IEC 18092 and ISO/IEC 21481 (ISO/IEC for “International Organization for Standardization”), which require the distance between the identification entity and the terminal to be of the order of a few centimeters at most, while other standards, such as the neighborhood interface standard ISO/IEC 15693, tolerate distances of the order of several decimeters.

Thus, by using an electromagnetic interface between the identification entity and the terminal, it is possible to protect oneself from identity theft, however service cut-offs may occur when the interface between the terminal and the identification entity is broken.

Such being the case, in some fields, it may be disadvantageous to undergo the interruption in service insofar as the interface between the terminal and the identification entity is broken. Such is the case, in particular, for critical communications, implemented, for example, by professional security and emergency professionals.

This invention aims to improve the situation.

### SUMMARY

A first aspect of this invention proposes a method of associating a user identity with an electronic terminal adapted for providing a service based on said user identity; said association method including the following steps, at the terminal level:

/1/ establishing a contactless transaction with an identification entity;

/2/ receiving a piece of information during said transaction, which relates to a user identity stored on said identification entity; and

/3/ storing said user identity obtained from said piece of information;

wherein the user identity is erased from the terminal when said terminal is subjected to a specific action.

In this way, the terminal is able to easily retrieve and store a user identity from an identification entity, this user identity being stored temporarily at the terminal since it is erased when the terminal is subjected to a certain action.

Such a specific action can, in particular, correspond to powering down the terminal or else to any user action on the terminal, or else an action implemented by an application loaded onto the terminal, e.g., such as the occurrence of an event inside the terminal (e.g., the deadline for a time-out or failure counter).

Owing to such arrangements, it is possible to ensure continuity in the service to which the user has access while at the same time maintaining a high level of security against theft of the user's identity. As a matter of fact, on the one hand, if the terminal is stolen from the user, since the identification entity is not physically linked to the terminal, it is not necessarily also stolen. On the other hand, it is not necessary for the transaction between the terminal and the identification entity to be in progress in order for the terminal to be capable of providing the service based on the user identity, since this user identity is stored in the terminal.

Furthermore, the storage of this user identity is temporary. To that end, it is advantageously provided for this user identity to be erased by an action applied to the terminal. This action can be applied either by a user or else by an application loaded onto the terminal.

Once the contactless transaction between the terminal and the identification entity has been established, the identity can then be transmitted from this entity to the terminal. At that moment, the identity can be stored in the terminal so as to enable the user to access the desired service.

In this way, the contactless interface between the terminal and the identification entity not only makes it possible to prevent theft of the user's identity and additionally does not require the transaction between the terminal and the identification entity to remain established throughout the use of the service in question.

It therefore suffices for the terminal and the identification entity to be capable of communicating for only a few moments in order for the terminal to be capable of receiving the user identity and, on this basis, of then taking advantage of a service.

Such a method according to one embodiment of this invention advantageously enables the user identity to be obtained quickly and independently of other subsequent transactions carried out by the terminal.

It bears noting that the disappearance, withdrawal or absence of the identification entity may not have any effect on the subsequent communications or transactions of the terminal.

Under these conditions, managing the protection of the operations, communications or else transactions of the terminal can remain separate from the management of the protection of the exchanges between the terminal and the user identification entity.

Such a characteristic is a sought-after advantage in the context of professional critical communications systems, in particular because the theft of the terminal being used does not involve the theft of the identification entity, unlike the case of a terminal adapted for a GSM or 3GPP type communication network. Furthermore, once the user identity has been obtained and stored in the terminal, the latter can carry out multiple operations without requiring a new transaction with the identification entity, until a specific action erasing the user identity has been implemented, the terminal has been powered down, or else, in the case where a identification entity presence detection (or “watch dog”) procedure has been implemented, until the user identity has been erased from the terminal.

By implementing an association method according to an embodiment of this invention, it is advantageously possible to eliminate the management of a password or PIN code (Personal Identification Number), as is the case, in particular, for unlocking the user of the keypad of a terminal adapted for GSM or UMTS type communications networks.

The implementation of an association method according to an embodiment of this invention is advantageously adapted to a general-purpose use of a terminal, i.e., the use of a terminal by various successive users.

Provisions can be made for the user to be capable of carrying out any manipulation of the terminal which enables the user identity stored in the terminal to be erased before ceasing use of same. Powering down the terminal can in particular enable this voluntary erasing of the stored identity.

A specific erasing function can further be provided in a menu of the terminal, via an application loaded onto the terminal, or else the erasure of this user identity can be controlled by pressing on one or more keys of the terminal's keypad.

The terminal is not operational, i.e., it cannot provide the service based on an identity, inasmuch as it does not possess this user identity. Prior to obtaining a user identity, the terminal can operate with another identity specific to the terminal. This terminal identity, for example, can be a serial number of the terminal.

The service provided at the terminal can be a local service with respect to the terminal or else a service provided via a communication network. A local service, for example, can correspond to an identity paper control carried out by scanning an identity paper at the terminal according to an embodiment of this invention. The user identity can then be used to authorize or prohibit the use of the terminal in question, on the basis of a list of user identifiers which is stored locally in the terminal. Besides the information relating to the user identity, it can further be provided for the identification entity to store a user profile, or subscriber profile, which is transmitted to the terminal in order to adapt the service or services provided to the user by the terminal. This invention is described here in the application thereof to a user identity, but is in no way limited to this single user identity. It is indeed easy to anticipate taking account of other information, in association with a user identity, such as individual parameters like a listed directory number, or a user profile, or else a security element, e.g., such as an ignition key or a security certificate, or a combination thereof.

In one embodiment of this invention, the information relating to the user identity is the user identity itself. Thus, in this case, the user identity can be retrieved directly from the identification entity.

In one embodiment of this invention, provisions are made for the terminal to be adapted for communicating in a communication network. It can then be provided for an association between the information relating to a user identity and the user identity to be managed at the communication network level, and for the terminal to obtain the user identity in step /3/, according to the following steps:

/i/ providing the information relating to a user identity to the communication network; and

/ii/ receiving said user identity from the communication network.

In this case, the user identity is not stored directly on the identification entity, the latter storing only one piece of information from which it is possible to obtain this user identity. The level of security against user identity theft is improved.

It can be anticipated for the method to further include the following steps:

/4/ determining if the identification entity is situated in proximity to the terminal;

/5/ repeating step /4/ N times, N being a whole number;

/6/ deciding to erase the user identity from the terminal if it is determined N consecutive times that the identification entity is not situated in proximity to the terminal.

The required distance between the terminal and the identification entity for detecting the presence of the identification entity at the terminal is based on the message exchange protocol used.

Such an embodiment of this invention enables the security level of the user identity to be further increased, since this user identity is erased from the terminal if the latter detects several consecutive times that the identification entity is not present in the vicinity. As a matter of fact, several detections of this type can cause strong suspicion about the fact that the actual user of the terminal is not who they claim to be, since they do not appear to possess the corresponding identification entity.

No limitation is attached to this invention, with regard to the messages exchanged between the terminal and the identification entity or else between the terminal and the communication network. Thus, in particular, such identification entity presence detection in the vicinity of a terminal can be implemented according to any protocol.

In particular, provisions can be made for the radio communication between the terminal and the identification entity aiming to provide the terminal with the information relating to the user identity to be of the NFC type (“Near Field Communication), e.g., such as the proximity interface standards ISO/IEC 14443, ISO/IEC 18092 and ISO/IEC 21481. In this case, this communication can be established when the distance between the terminal and the identification entity is between approximately 4 cm and 10 cm. Since this distance is relatively small, protection of the user identity is improved, and the consumption of energy by the terminal is also advantageously low.

It is likewise possible to anticipate for the radio interface between the terminal and the identification entity to be of another type which supports larger distances between the terminal and the identification entity, e.g., such as the ISO/IEC 15693 neighborhood interface standard.

In one embodiment of this invention, a terminal can manage a neighborhood interface in addition to the proximity interface used for retrieving the identity according the above-described method. In this case, when the terminal uses an identification entity, provisions can be made for a watch dog timer to be triggered.

The method of temporarily associating a user identity and a terminal can then optionally include the following steps at the terminal, which steps can be carried out in parallel with other steps:
periodically activating the neighborhood communication interface for a certain period of time, e.g., upon expiration of a timer; and verifying the presence of the vicinity of the identification identity used;
if the presence of the identification entity is verified, resetting the timer and, preferably, deactivating the neighborhood communication interface, in order to economize on energy consumption;

if the timer expires before an identification entity has been able to be detected as present in the vicinity of the terminal, the user of the terminal is warned, via a visual or sound signal. Optionally in this case, the current identity of the user is erased from the terminal.

In one embodiment of this invention, a terminal can simultaneously manage an NFC-type message exchange protocol and another type of protocol.

When the terminal is adapted for communicating in a communication network, provisions can be made, after step /3/, for the terminal to emit a signal, e.g., a sound signal. In this way, the user is informed of a correct initialization of the terminal they are using, with regard to the user identity of same.

After step /3/, the terminal can next advantageously register with the communication network based on the user identity. The user can then take advantage of the service or services provided in this network with regard to the user identity thereof.

Prior to step /3/, when the terminal is adapted for communicating in a communication network, the terminal registers with the communication network on the basis of an identity of the terminal, and then, after step /3/, on the basis of the user identity.

In this case, even before the terminal has stored the user identity, it is capable of quickly taking advantage of the service or services provided in the communication network, without the user identity, e.g., such as access to an emergency telephone number.

Provisions can advantageously be made for steps /1/ to /3/ to be implemented during a user movement of the terminal consisting in moving the terminal closer to the identification entity. In this way, for example, the user of the terminal can wear the identification entity, like a badge. In this case, in order to be capable of using a terminal according to one embodiment of this invention, they can retrieve their user identity by a simple hand gesture aiming to move the terminal closer to the identification entity thereof for a brief period of time, which can be a few seconds.

A second aspect of this invention proposes a terminal adapted for implementing an association method according to the first aspect.

A third aspect of this invention proposes a system for associating a user identity, including a terminal according to the second aspect of this invention, and an identification entity on which a piece of information relating to a user identity is stored.

Other aspects, objectives and advantages of the invention will become apparent upon reading the description of one of the embodiments thereof.

### BRIEF DESCRIPTION OF THE DRAWINGS

The invention will likewise be better understood with the aid of the drawings, in which:

FIG. 1 shows an application of an embodiment of this invention;

FIG. 2 shows an exchange of messages between a terminal and an identification entity according to an embodiment of this invention enabling a certain level of security against identity theft to be ensured;

FIG. 3 shows an exchange of messages between a terminal, an identification entity and the network, which relates to registering a terminal with the network, according to an embodiment of this invention;

FIG. 4 shows an exchange of messages between a terminal, an identification entity and a network, which relates to the management of a dual registration of a terminal with the network, according to an embodiment of this invention;

FIG. 5 shows an exchange of messages between a terminal, an identification entity and a network, according to an embodiment of this invention, during which the user identity is obtained from the network, and

FIG. 6 shows a system for associating a user identity according to an embodiment of this invention.

### DETAILED DESCRIPTION OF THE DRAWINGS

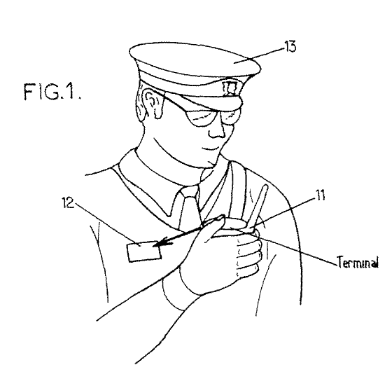

FIG. 1 shows an application of an embodiment of this invention. A user 13 has a terminal 11 and an identification entity 12 according to an embodiment of this invention. In this case, provisions can be made for the identification entity 12 to be worn by the user at chest level and, at the moment when the terminal 11 of same is initialized, for the user to move this terminal 11 close to the location where they are wearing this identification entity 12. In this way, the transaction between the identification entity 12 and the terminal can be established according to an embodiment of this invention, so that the terminal can subsequently possess the user identity of the user 13, on the basis of which they can use a service which is provided. The transaction enabling the terminal to retrieve the identity can be implemented by carrying out a movement of moving the terminal towards the identification entity. It can be provided for the terminal to emit a signal, such as a sound signal, once the identity has been retrieved. In this way, following emission of this signal, the terminal can then be moved away from identification entity.

It is appropriate to provide for the terminal to only temporarily possess a user identity, in order to anticipate a potential theft.

To that end, provisions are made to erase the user identity by implementing a specific action on the terminal, e.g., such as powering down the terminal. In this way, at best, the terminal possesses the user identity only temporarily.

In one embodiment of this invention, in order to increase protection against a potential theft of the user's identity, it can be advantageously anticipated to put a time verification in place, in terms of the identification entity presence time in the vicinity of the terminal which has stored the corresponding identity, via a complementary contactless neighborhood interface of the contactless proximity interface used for the preceding transaction.

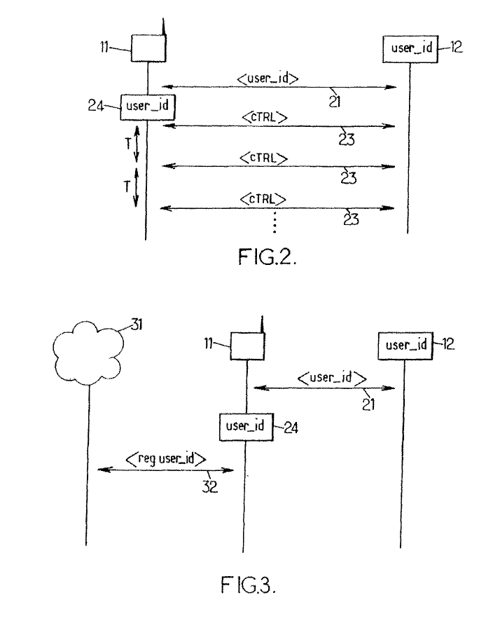

FIG. 2 shows an exchange of messages between a terminal and an identification entity according to one embodiment of this invention, enabling the security level against identity theft to be increased.

In this case, an exchange of messages 21 <user id> corresponds to the transaction between the terminal 11 and the identification entity 12 during which the user identity user-id is retrieved by the terminal. This exchange of messages can be a secure exchange of messages for increasing the protection against possible theft of the user's identity.

Once the identity has been thus retrieved from the terminal, it is stored therein at step 24. In order to ensure security against identity theft, provisions can advantageously be made to implement protection by means of a watch dog mechanism between the terminal 11 and the identification entity 12, so as to verify that, at least now and again, the terminal 11 is in proximity to the identification entity 12, from which it has retrieved the user identity that it stored. In this way, once the transaction has been established between the terminal and the identification entity, and the terminal 11 has stored the identity which enables same to use the service in question, the terminal occasionally verifies the close presence of the identification entity 12.

Such a “watch dog” can consist of a succession of presence verification message exchanges 23 <CTRL>, each of these message exchanges aiming to determine the presence or non-presence of the identification entity 12 within proximity to the terminal 11. Two successive message exchanges 23, for example, can be separated by a time period T.

It can then advantageously be provided that, if a number N of successive message exchanges 23 enables the terminal to determine that the identification entity 12 is not within proximity to the terminal 11, the terminal erases the stored identity. As a matter of fact, under these conditions, identity theft may be suspected since it is assumed that the user of this identity possesses its identification entity within proximity to the terminal that it is using and that, for this reason, it can at least occasionally detect the presence thereof.

It can further be anticipated for the user to be informed of this negative presence verification, and of the erasure of the user identity from the terminal, via a signal, e.g., a light or sound signal produced at the terminal.

The values of T and N can advantageously be determined based on the application of an embodiment of this invention.

The terminal is adapted to implement the exchange of messages 23 aiming to detect the presence of the identification entity 12 in the vicinity thereof. No limitation is attached to this invention with regard to this exchange of messages.

Under such conditions, even if the transaction between the terminal and the identification entity is interrupted, the terminal still possesses the user's identity. However, since the absence of the identification entity 12 is detected at the terminal 11 for a certain time period, by measuring security against identity theft, this user identity is erased from the terminal 11.

Consequently, this embodiment makes it possible to ensure continuity of service at the terminal, even if the terminal 11 is sometimes distant from the identification entity 12, while at the same ensuring a high level of security against user identity theft.

In one modality, the presence verification of the identification entity by the terminal is carried out by a contactless electromagnetic neighborhood interface instead of being carried out by the contactless proximity interface used for transferring the identity.

In one embodiment of this invention, the terminal is adapted for communicating in a communication network 31, and the user identity is intended for use in the communication network 31 so as to access one or more communication services at the terminal 11.

FIG. 3 shows an exchange of messages between the terminal 11, the identification entity 12 and the network 31, which relates to registration of a terminal with the communication network in which it can communicate, according to one embodiment of this invention.

First and foremost, the terminal 11 retrieves the user identity user-id of the user thereof from the identification entity 12, during the exchange of identification messages 21 <user-id> and stores same locally in step 24.

The terminal 11 is then capable of being registered, on the basis of this identity user-id, by implementing a user registration message exchange 32 <reg user-id> with the communication network 31.

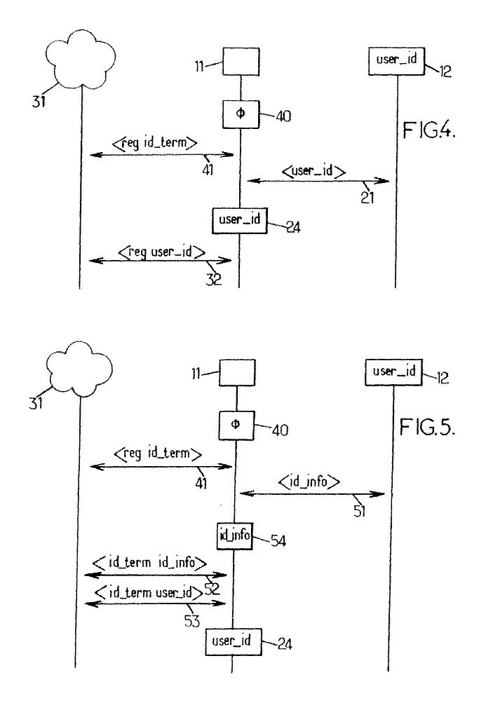

FIG. 4 shows an exchange of messages between the terminal, the identification entity and the network, which relates to the management of a dual registration of a terminal with the network, according to one embodiment of this invention. This exchange can be implemented when the terminal 11 has an identity which is specific thereto, id-term.

In one embodiment of this invention, when the terminal 11 is powered down, it does not possess any user identity, as shown in step 40. Thus, before the identification message exchange 21 is implemented, at the moment when the terminal is initialized, the latter can register itself with its own identifier id-term according to a terminal registration message exchange 41 <reg id-term>.

Then, once the user identity has been retrieved, at step 24, via the exchange of identification messages 21, the terminal can then register with the network based on the user identity, via an exchange of user registration messages 32.

This embodiment advantageously enables an increase in the efficiency of the method of registering a terminal with a network which requires both an identity for the terminal and an identity for the user, by first enabling the terminal to be registered before the user identity retrieval procedure has been carried out.

It can likewise be particularly advantageous when the network in question 31 further provides services based on the registration of the terminal alone. As a matter of fact, the user can then use these services while waiting to obtain the user identity user-id and implement the user registration 32.

In an alternative of the embodiment of this invention, described in reference to FIG. 4, provisions can be made to provide the network 31, in an associated manner, with both the identity specific to the terminal id-term and the user identity user-id, during a single exchange of messages, the registration message exchange 32.

FIG. 5 shows an exchange of messages between the terminal 11, the identification entity 12 and the network 32, according to an embodiment of this invention, during which the user identity is finally obtained from the network.

In this embodiment, upon initialization of the terminal 11, the latter does not possess any locally stored user identity, as shown in step 40. In the first place, in its initialization phase, the terminal 11 implements a terminal registration with the communication network 31, on the basis of the exchange of messages 41 <reg id-term>, thereby providing the network 31 with its own identifier id-term.

Next, it implements the step consisting in retrieving a user identity user-id. In this embodiment of this invention, the user identity itself is not directly stored in the identification entity 12 held by the user of the terminal 11. The identification entity 12 here stores only information id-info enabling the user identity to be subsequently retrieved from the network 31.

In this way, the step consisting in retrieving the user identity at the terminal is broken down into two parts at the terminal, a first part consisting in retrieving the user information id-info from the identification entity 12, and a second part consisting in retrieving the user identity user-id from the network 31, on the basis of the user information id-info. In this case, provisions can be made for the network 31 to include a directory server which is adapted for managing an association between user information and a user identity.

The terminal first implements the first part according to an exchange of messages 51 with the identification entity 12, during which it retrieves the user information which is stored on this identification entity 12.

In one particular embodiment, provisions can be made for the terminal to store the user information id-info, as shown in step 54 of FIG. 5.

It then proceeds with retrieving the user identity in itself from the network 31, on the basis of the user information, via an exchange of identification messages with the network, during which it provides the user information in a message 52 and receives in exchange the associated user identity user-id in a message 53.

The message 52 can further indicate the terminal identity id-term, in order to enable only one previously registered terminal to be capable of obtaining a user identity.

Upon receipt of the message 53 indicating the user identity user-id, the terminal 11 stores it in step 24.

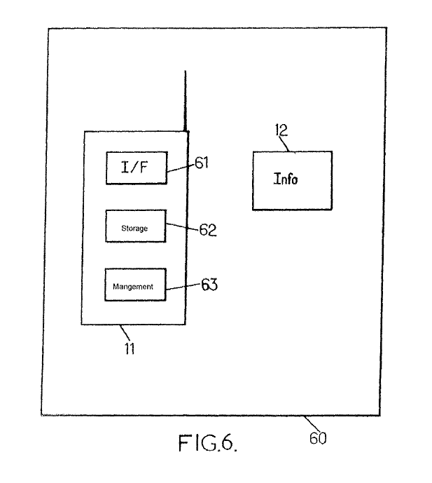

FIG. 6 shows a system for associating a user identity according to an embodiment of this invention.

Such a system of association 60 includes an identification entity 12 storing information relative to a user identity and a terminal 11, according to an embodiment of this invention. The latter includes:
a radio interface unit 61 adapted for establishing a transaction 21 with an identification entity 12 and for receiving information relative to a user identity stored on said identification entity, during said transaction;
a storage unit 62 adapted for storing said user identity obtained from said information relative to a user identity; and
a storage management unit 63 adapted for erasing the user identity when the terminal is subjected to a specific action.

When the terminal is adapted for communicating in the communication network 31, the radio interface unit 61 can further be adapted for providing the user information to the communication network 31, via message 52, and for receiving the user identity from the communication network 31, via message 53.

The radio interface unit 61 can further be adapted for determining if the identification entity 12 is situated in proximity to the terminal and the storage management unit 63 can further be adapted for deciding to erase the user identity when the radio interface unit determines N consecutive times that the identification entity is not situated in proximity to the terminal, N being any whole number.

The terminal according to an embodiment of this invention is responsible for providing power to the contactless identification entity. The terminal, for example, can be terminal equipment for a communication system, such as a professional mobile radio (PMR) system.

The identification entity 12 can correspond to a contactless proximity smart card. For example, it can be a business card worn by the user on their chest or carried in their wallet, or else an identification card, a driver's license or a travel document.

Provisions can be made for the radio interface between the terminal 11 and the identification entity 12 to be deactivated as soon as the user identity has been stored at the terminal, except when an identification entity presence control procedure has been implemented, as shown in FIG. 2.

As a matter of fact, in this case, it can be provided for the terminal to then periodically and temporarily activate its radio interface only for a specific time period enabling same to implement an identification entity presence control operation in the vicinity. By operating in this way, it is possible to save energy with regard to the terminal.

1. Method of associating a user identity (user-id) with an electronic terminal adapted for providing a service based on said user identity; said association method including the following steps, at the terminal level:
/1/ establishing a contactless transaction with an identification entity;
/2/ receiving a piece of information during said transaction, which relates to a user identity stored on said identification entity; and
/3/ storing said user identity obtained from said piece of information;
wherein the user identity is erased from the terminal when said terminal is subjected to a specific action;
wherein the terminal is adapted for communicating in a communication network;
wherein an association between the information relative to a user identity and the user identification is managed by the communication network, and
wherein the terminal obtains the user identity in step /3/, according to the following steps:
/i/ providing the information relating to a user identity to the communication network;
/ii/ receiving said user identity from the communication network.

2. Method of associating a user identity as claimed in claim 1, further including the following steps at the terminal:
/4/ determining if the identification entity is situated in proximity to the terminal;
/5/ repeating step /4/ N times, N being a whole number;
/6/ deciding to erase the user identity from the terminal if it is determined N consecutive times that the identification entity is not situated in proximity to the terminal.

3. Method of associating a user identity as claimed in claim 1, wherein, after step /3/, the terminal emits a sound or light signal.

4. Method of associating a user identity as claimed in claim 1, wherein the terminal is adapted for communicating in a communication network; and wherein, after step /3/, the terminal registers with the communication network, on the basis of the user identity.

5. Method of associating a user identity as claimed in claim 1, wherein the terminal is adapted for communicating in a communication network; and wherein, prior to step /3/, the terminal registers with the communication network on the basis of an identity of the terminal, then, after step /3/, on the basis of the user identity.

6. Method of associating a user identity as claimed in claim 1, wherein steps /1/ to /3/ are implemented during a user movement of the terminal consisting in moving the terminal closer to the identification entity.

7. Terminal adapted for providing a service based on a user identity; said terminal being adapted for communicating in a communication network; comprising:
an association between the information relative to a user identity and the user identification being managed by the communication network,
said terminal including:
a radio interface unit adapted for establishing a transaction with an identification entity and for receiving information relative to a user identity stored on said identification entity, during said transaction;
a storage unit adapted for storing said user identity obtained from said information relative to a user identity; and
a storage management unit adapted for erasing the user identity when the terminal is subjected to a specific action;
means for providing the information relating to a user identity to the communication network;
means for receiving said user identity from the communication network.

8. Terminal of claim 7, wherein the radio interface unit is further adapted for providing the user information to the communication network and for receiving said user identity from the communication network.

9. Terminal as claimed in claim 7, wherein the radio interface unit is further adapted for determining if the identification entity is situated in proximity to the terminal; and
wherein the storage management unit is further adapted for deciding to erase the user identity when the radio interface unit determines N consecutive times that the identification entity is not situated in proximity to the terminal, N being any whole number.

10. System for associating a user identity, including a terminal comprising:
an association between the information relative to a user identity and the user identification being managed by a the communication network,
said terminal including:
a radio interface unit adapted for establishing a transaction with an identification entity and for receiving information relative to a user identity stored on said identification entity, during said transaction;
a storage unit adapted for storing said user identity obtained from said information relative to a user identity; and
a storage management unit adapted for erasing the user identity when the terminal is subjected to a specific action;
means for providing the information relating to a user identity to the communication network;
means for receiving said user identity from the communication network; and
an identification entity on which information relative to a user identity is stored.

11. System of claim 10, wherein the radio interface unit is further adapted for providing the user information to the communication network and for receiving said user identity from the communication network.

12. System of claim 10, wherein the radio interface unit is further adapted for determining if the identification entity is situated in proximity to the terminal; and
wherein the storage management unit is further adapted for deciding to erase the user identity when the radio interface unit determines N consecutive times that the identification entity is not situated in proximity to the terminal, N being any whole number.
